(19) United States
(12) Patent Application Publication
(10) Pub. No.: US 2005/0193524 A1
(43) Pub. Date: Sep. 8, 2005

(54) Pivot structure for a foldable product

(75) Inventors: Cheng Hsien Wang, Taipei (TW); Ya-Yun Huang, Taipei (TW)

Correspondence Address: TROXELL LAW OFFICE PLLC, SUITE 1404, 5205 LEESBURG PIKE, FALLS CHURCH, VA, 22041, US

(73) Assignee: FIRST INTERNATIONAL COMPUTER INC.

(21) Appl. No.: 10/792,877

(22) Filed: Mar. 5, 2004

(51) Int. Cl. E05D 3/10

(52) U.S. Cl. 16/367

(57) ABSTRACT

A pivot structure is used to a foldable product. The pivot structure includes a first pivot, a second pivot, and a pivot structure that is disposed between the first portion and the second portion. The first pivot with one side is pivoted with the first portion and has an axial slot formed at another side. The second pivot with a side has a protrusion inserted into the slot and is pivoted with another side of the first pivot. The second pivot is connected to the second portion. Furthermore, the first and the second portion are separated to each other, the second pivot of the pivot structure can be returned to an inside portion of the first portion preventing the pivot structure from projecting from an outline of the first portion.

### BACKGROUND OF THE INVENTION

(1) Field of the Invention

The present invention relates to a pivot structure for a foldable product, and especially to a pivot structure arranged between a first portion and a second portion. The first and second portion can open and close to each other by the pivot structure.

(2) Description of the Related

Referring to FIGS. 1 and 1A, the prior art provides a foldable product. For example, the foldable produce is a notebook, a hand-held computer, a cellular phone, a translation device or a personal digital assistant. The foldable produce of the FIGS. 1 and 1A is the notebook. The notebook has a monitor, a body and a pivot structure. The pivot structure is disposed between the monitor and the body for opening and closing the foldable produce.

The foldable product includes a first portion 1, a second portion 2, and a pivot structure 3 that is disposed between the first portion 1 and the second portion 2. Further, the first portion 1 includes a concave portion 11. The concave portion 11 has a hole (not show in FIG. 1A) formed at a lateral wall 111. The second portion 2 includes a mating portion 21 corresponding to the concave portion 11 and a mating hole 211 formed in the mating portion 21. The mating portion 21 has a lateral first hole 2111 and a vertical second hole 2112.

The pivot structure 3 includes a lateral pivot 31 with one end pivoted in the hole of the concave portion 11, a cover body 32 surrounding the lateral pivot 31, and a vertical pivot 33 integrally extended from the cover body 32 and received into the mating hole 211. The vertical pivot 33 has a radial first hole 331 corresponding to the first hole 2111 and an axial second hole 332 corresponding to the second hole 2112. The foldable product further includes a fixed element 34 disposed between the two first holes (2111 and 331) and the two second holes (2112 and 332) for fixing the pivot structure 3 on the second portion 2. So the first portion 1 and the second portion 2 are foldable each other by the lateral pivot 31 of the pivot structure 3.

The first portion 1 can be separated from the second portion 2 to singly use. However, when the first portion 1 with the pivot structure 3 is separated from the second portion 2, the pivot structure 3 will be projected out of an outline of the first portion 1 (the pivot structure can not be returned into an inside portion of the first portion). So that the first portion 1 is not easy and convenient to dispose, carry and singly use.

With the employment of unique considerations and application of theories, and based on several years experience in specialized production of all flexible assembly systems and mechanisms, so that the inventor has come up with an innovative pivot structure for the foldable product.

### SUMMARY OF THE INVENTION

The primary object of the present invention is to provide a pivot structure for a foldable product. The foldable product includes a first portion, a second portion, and a pivot structure. When the first and the second portion are separated to each other, the pivot structure is also foldable. So the pivot structure does not project from an outline of the first portion. Furthermore, the first portion is easy and convenient to dispose, carry and singly use.

In order to achieve the above objects, the present invention provides a pivot structure for a foldable product. The foldable product has a first portion and a second portion. The pivot structure comprises a first pivot and a second pivot.

The first pivot with one side is pivoted with the first portion and has an axial slot formed at another side. The second pivot with a side has a protrusion inserted into the slot and is pivoted with another side of the first pivot. The second pivot is connected to the second portion.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The various objects and advantages of the present invention will be more readily understood from the following detailed description when read in conjunction with the appended drawing, in which:

FIG. 1 is a perspective view of the first and the second portion of the prior art;

FIG. 1A is a local enlargement view of A-portion of the FIG. 1 of the prior art;

FIG. 2 is one perspective view of the first and the second portion of the present invention;

FIG. 2A is a local enlargement view of A-portion of the FIG. 2 of the present invention;

FIG. 2B is a local enlargement view of B-portion of the FIG. 2 of the present invention;

FIG. 3 is another perspective view of the first and the second portion of the present invention;

FIG. 4 is an exploded view of the pivot structure of the present invention;

FIG. 5 is a perspective view of the pivot structure of the present invention;

FIG. 6 is a perspective view of the pivot structure connected with the first portion according to the present invention;

FIG. 7 is a perspective view of the pivot structure and the frame body respectively separated from the first portion according to the present invention;

FIG. 8 is a side view of the pivot structure moved according to the FIG. 7; and

FIG. 9 is a side view of the pivot structure rotated according to the FIG. 8.

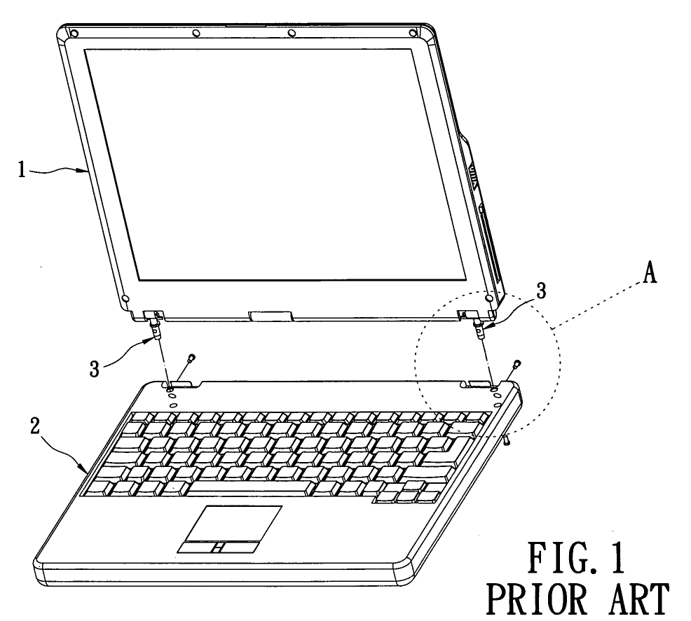

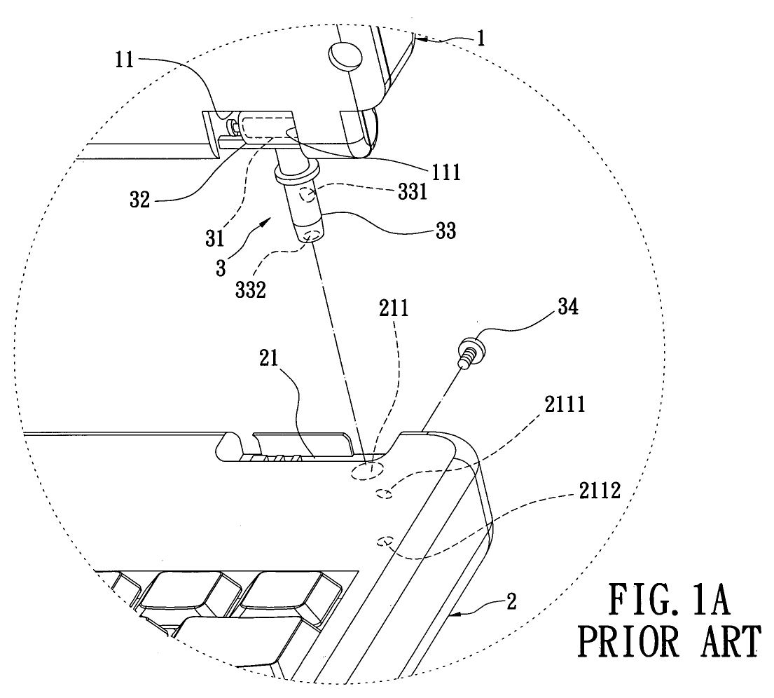

### DETAILED DESCRIPTION OF THE PREFERRED EMBODIMENT

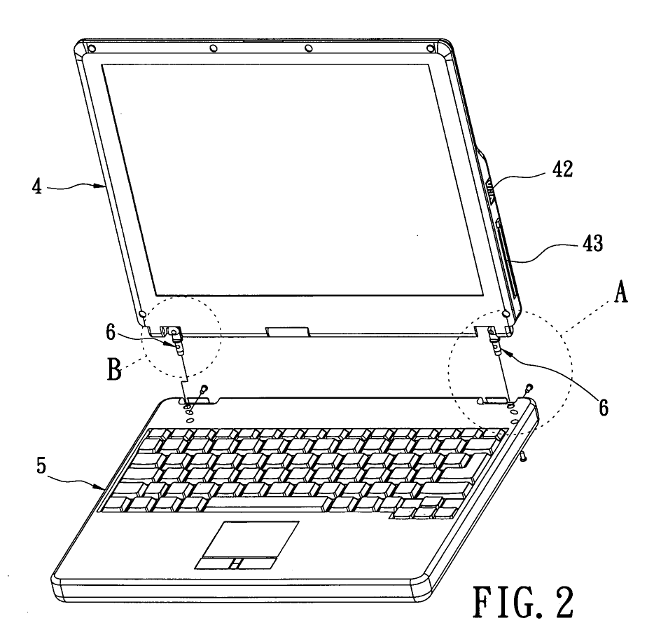

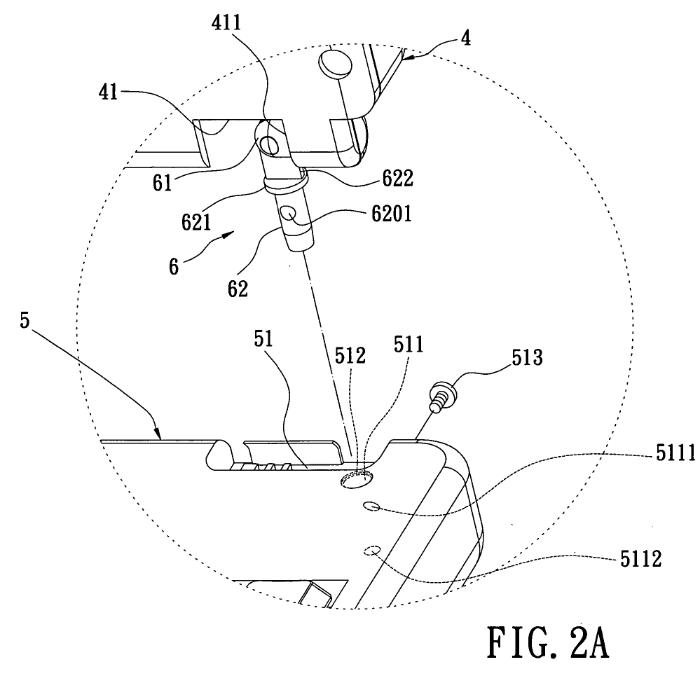

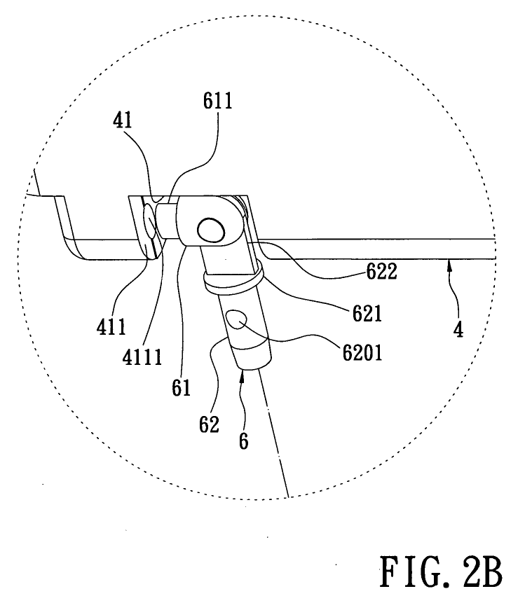

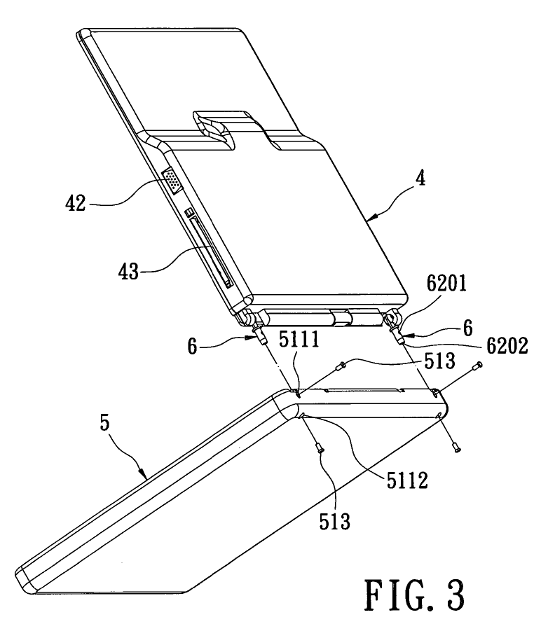

Referring to FIGS. 2 to 6, the present invention provides a pivot structure for a foldable product. The foldable produce is a notebook, a hand-held computer, a cellular phone, a translation device or a personal digital assistant. The foldable product comprises a first portion 4, a second portion 5, and a pivot structure 6 that is disposed between the first portion 4 and the second portion 5.

The first portion 4 includes a concave portion 41 formed at one side thereof The concave portion 41 has a hole 4111 formed at a lateral side 411 thereof. (Referring to the FIG. 2B).

The second portion 5 includes a mating portion 51 formed at one side thereof and corresponding to the concave portion 41. The mating portion 51 has a mating hole 511, a concave edge 512 formed in the mating hole 511, a radial first hole 5111 communicated with the mating hole 511, and an axial second hole 5112 communicated with the mating hole 511.

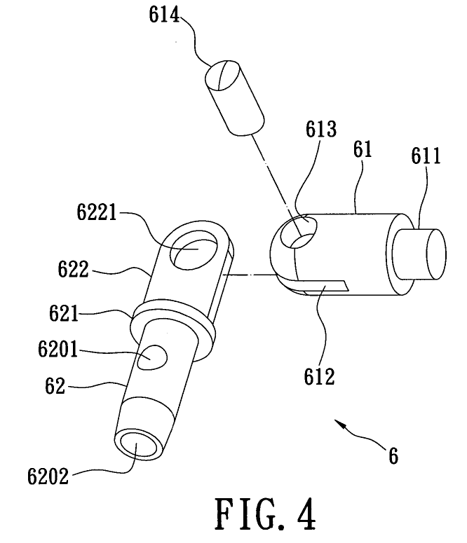

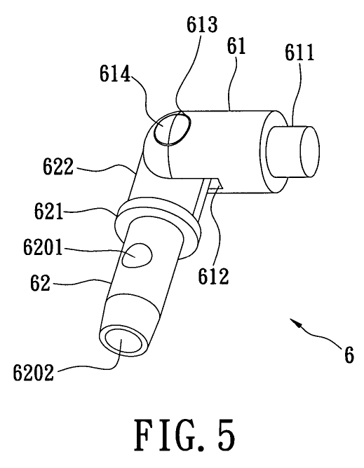

Referring to the FIGS. 4 and 5, the pivot structure 6 includes a first pivot 61 and a second pivot 62 pivoted to each other. The first pivot 61 has a pivot body 611 axially extended from one side thereof and an axial slot 612 formed at another side thereof. The first pivot 61 with another side further comprises a radial through hole 613 communicated with the axial slot 612.

The second pivot 62 includes a protrusion 622 formed at one side thereof and inserted into the slot 612. The protrusion 622 has an axial through hole 6221 corresponding to the radial through hole 613. Furthermore, using a pivot element 614 to pivot between the radial through hole 613 and the axial through hole 6221. So the first pivot 61 and the second pivot 62 are pivoted to each other by the pivot element 614.

The second pivot 62 further comprises a protrusion edge 621 radially formed between the one end of the second pivot 62 and the protrusion 622. The protrusion edge 621 is corresponding to the concave edge 512. The second pivot 62 further comprises a first opening 6201 and a second opening 6202 corresponding to the first hole 5111 and the second 5112, respectively.

Besides, the pivot body 611 of the first pivot 61 is axially pivoted in the hole 4111 for rotating the first pivot 61. The second pivot 62 is axially received in the mating hole 511 of the mating portion 51. At the same time, the protrusion edge 621 of the second pivot 62 is inserted into the concave edge 512 of the mating portion 51 for getting the fixed position effect. The first hole 5111 and the first opening 6201, and the second hole 5112 and the second opening 6202 are fixed to each other by a fixed element 513, respectively. Whereby the first portion 4 and the second portion 5 are closed or opened to each other by the pivot structure 6.

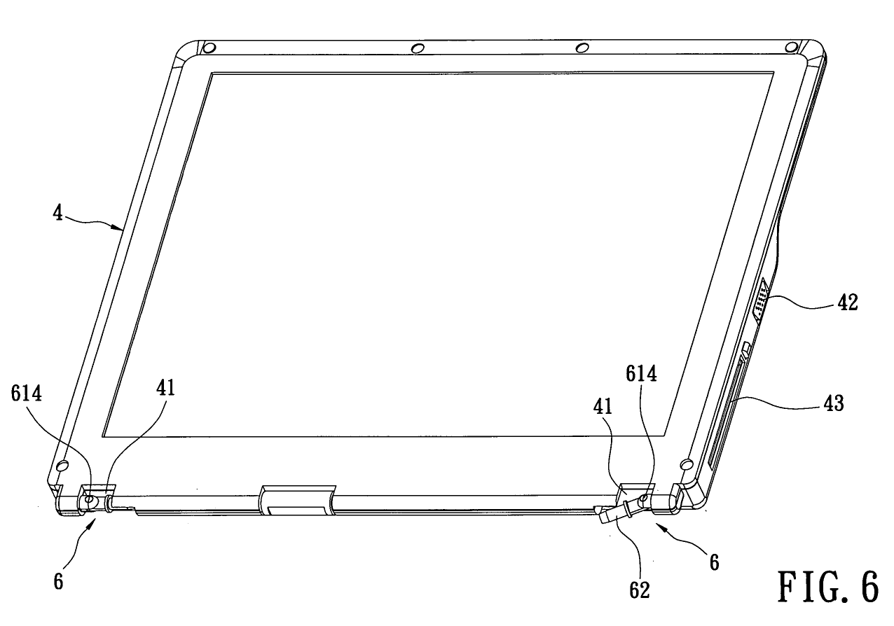

When disassembling the fixed element 513, the second pivot 62 can be separated from the mating hole 511, and the first portion 4 and the second portion 5 are separated to each other. Referring to the FIG. 6, the first portion 4 is already separated from the second portion 5, so the pivot structure 6 can be returned to the concave portion 41 around the pivot element 614 for preventing the pivot structure 6 from projecting from an outline of the first portion 4.

In other words, the first pivot 61 can be returned to parallel with the second pivot 62. So the first portion 4 and the second portion 5 are separated to each other, the second pivot 62 of the pivot structure 6 is foldable for preventing the pivot structure 6 from projecting from the outline of the first portion 4.

Referring to the FIG. 6, the second pivot 62 of the pivot structure 6 is folded into the concave portion 41 of the first portion 4 for hiding the second pivot 62 from concave portion 41.

When the first portion 4 is separated from the second portion 5, the first portion 4 can be singly used. For example, the first portion can be a LCD monitor. The first portion further comprises an electrical connector 42 and a socket 43 for receiving external signals. So the first portion can use the electrical connector 42 or a socket 43 to display the information of the external signals.

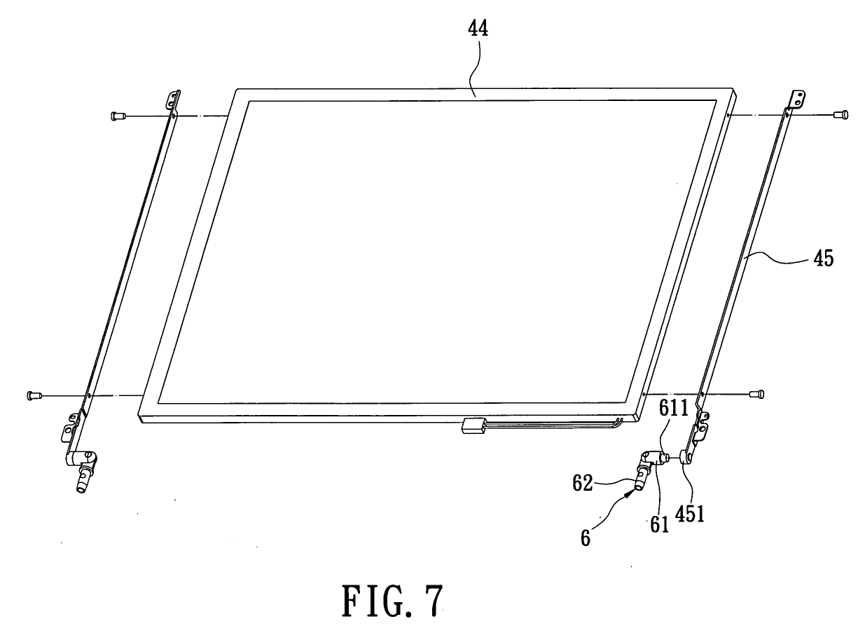

Referring to the FIG. 7, the first portion 4 further comprises a LCD body 44 and a pair of frame bodies 45 disposed at two sides thereof. Each of the frame bodies 45 has a cover body 451 formed at low side thereof for receiving the pivot body 611. The cover body 451 and the hole 4111 corresponding to each other.

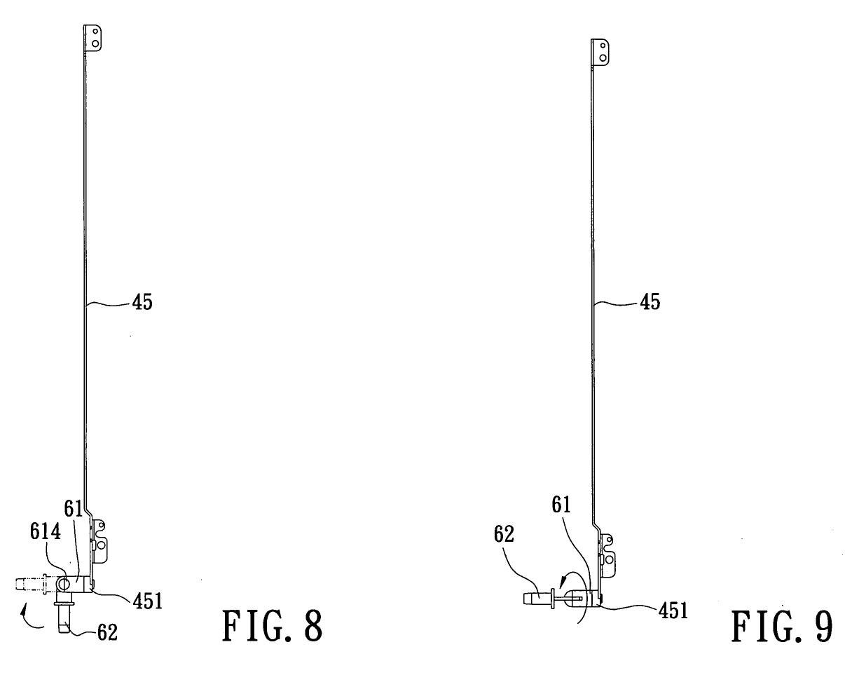

Referring to the FIGS. 8 and 9, the pivot structure 6 can be bended to and fro on the pivot element 614 and rotated around the pivot body 611 of the first portion 61.

Although the present invention has been described with reference to the preferred embodiment thereof, it will be understood that the invention is not limited to the details thereof. Various substitutions and modification have suggested in the foregoing description, and other will occur to those of ordinary skill in the art. Therefore, all such substitutions and modifications are intended to be embraced within the scope of the invention as defined in the appended claims.

1. A pivot structure for a foldable product, the foldable product having a first portion and a second portion, the pivot structure comprising:
a first pivot having two sides, one side pivoted with the first portion and an axial slot formed at another side; and
a second pivot having a protrusion arranged at a side thereof to insert into the slot, the protrusion pivoted with the other side of the first pivot, and the second pivot connected to the second portion.

2. The pivot structure as claimed in claim 1, wherein the other side of the first pivot further comprises a radial through hole communicated with the axial slot, the protrusion further comprises an axial through hole corresponding to the radial through hole, and the pivot structure further comprises a pivot element pivoted between the radial and the axial through hole.

3. The pivot structure as claimed in claim 1, wherein the first portion further comprises a concave portion having a hole formed at a lateral wall thereof, one side of the first pivot pivoted in the hole of the concave portion.

4. The pivot structure as claimed in claim 3, wherein one side of the first pivot further comprises a pivot body axially projected therefrom, and the pivot body pivoted in the hole of the concave portion.

5. The pivot structure as claimed in claim 1, wherein the second portion further comprises a mating portion having a mating hole, and the second pivot inserted in the mating hole.

6. The pivot structure as claimed in claim 5, wherein the second pivot further comprises a first hole and a second hole, the first hole radially disposed at the second pivot, and the second hole axially disposed at the other side of the second pivot.

7. The pivot structure as claimed in claim 6, wherein the mating portion of the second portion further comprises a first opening and a second opening, the first and the second opening corresponding to the first and the second hole of the second pivot, the first opening and the first hole fixed to each other by one fixed element, and the second opening and the second hole fixed to each other by another fixed element.

8. The pivot structure as claimed in claim 5, wherein the second pivot further comprises a protrusion edge radially formed between the one end of the second pivot and the protrusion, the mating hole of the second portion including a concave edge formed therein and corresponding to the protrusion edge.

9. The pivot structure as claimed in claim 1, wherein the foldable produce is a notebook, a hand-held computer, a cellular phone, a translation device or a personal digital assistant.

10. The pivot structure as claimed in claim 1, wherein the first portion further comprises an electrical connector or a socket.
